(19) United States
(12) Patent Application Publication
(10) Pub. No.: US 2025/0137793 A1
(43) Pub. Date: May 1, 2025

(54) DEVICE AND METHOD FOR CONTROLLING VEHICLE

(71) Applicants: HYUNDAI MOTOR COMPANY, SEOUL (KR); KIA CORPORATION, SEOUL (KR); POSTECH RESEARCH AND BUSINESS DEVELOPMENT FOUNDATION, POHANG-SI (KR)

(72) Inventors: Harn Song Lee, Hwaseong-si (KR); Seok Ki Hong, Hwaseong-si (KR); Hwan Jo Yu, Pohang-si (KR); Jun Su Cho, Pohang-si (KR)

(73) Assignees: HYUNDAI MOTOR COMPANY, SEOUL (KR); KIA CORPORATION, SEOUL (KR); POSTECH RESEARCH AND BUSINESS DEVELOPMENT FOUNDATION, POHANG-SI (KR)

(21) Appl. No.: 18/929,890

(22) Filed: Oct. 29, 2024

(30) Foreign Application Priority Data
Oct. 31, 2023 (KR) 10-2023-0148148

(51) Int. Cl. G01C 21/34; G01C 21/36

(52) U.S. Cl. CPC G01C 21/3476; G01C 21/3446; G01C 21/3617; G01C 21/3682

(57) ABSTRACT

A device for controlling a vehicle includes a navigation system that acquires big data including a point of interest (POI) with a visit history of a requestor who has requested a place recommendation, and a processor that performs preprocessing on the big data for learning acquired in advance to generate input data, trains a POI recommendation model based on the input data, and inputs the big data into the POI recommendation model that has been trained to generate at least one place the requestor is expected to visit.

### CROSS REFERENCE TO RELATED APPLICATIONS

This application claims the benefit of priority to Korean Patent Application No. 10-2023-0148148, filed in the Korean Intellectual Property Office on Oct. 31, 2023, the entire contents of which are incorporated herein by reference.

### TECHNICAL FIELD

The present disclosure relates to a device and a method for controlling a vehicle, and more specifically, to a device and a method for controlling a vehicle that guide a place a user is expected to visit.

### BACKGROUND

Recently, a technology to recommend a place that a user is likely to visit using big data has been developed. Generally, among schemes of recommending the place that the user is likely to visit, a scheme of increasing a probability of visit of a place that is close to a position of a user is chosen. However, the user is more likely to visit a place that is a certain distance away from the position of the user rather than the place that is close to the position of the user, so that improvement of the recommendation scheme is required.

In addition, because only position information of the user is used to recommend the place that the user is likely to visit, a situation of the user is not accurately reflected, which has a limitation of low satisfaction of the user.

Therefore, to improve the satisfaction of the user, a technology to recommend the place that the user is likely to visit by reflecting not only the position information of the user but also information on a time the user visits the place and the like is required.

### SUMMARY

The present disclosure has been made to solve the above-mentioned problems occurring in the prior art while advantages achieved by the prior art are maintained intact.

An aspect of the present disclosure provides a device and a method for controlling a vehicle that generate a point of interest (POI) recommendation model for each POI category and recommend a place a user is expected to visit considering a position of the user, a current time, an age of the user, and a POI category selected by the user.

Another aspect of the present disclosure provides a device and a method for controlling a vehicle that generate a POI recommendation model that learns a movement pattern of a user over time, scores a distance between the user and a POI, personalizes the scored distance value, and outputs a place the user is expected to visit based on the movement pattern of the user over time and the scored distance value.

Another aspect of the present disclosure provides a device and a method for controlling a vehicle that provide a place recommendation service that outputs a place a user is expected to visit by considering not only a position of the user but also a movement pattern over time to enable intuitive recognition of the user and improve satisfaction of the user.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device for controlling a vehicle includes a navigation system that acquires big data including a POI with a visit history of a requestor who has requested a place recommendation, and a processor that performs preprocessing on the big data for learning acquired in advance to generate input data, trains a POI recommendation model based on the input data, and inputs the big data into the POI recommendation model that has been trained to generate at least one place the requestor is expected to visit.

In one implementation, the processor may perform the preprocessing to extract user information and POI information from the big data for the learning and generate first preprocessing data, extract a POI with a history of being set as a destination from the first preprocessing data and generate second preprocessing data, extract only a POI category to be learned from the second preprocessing data and generate third preprocessing data, and remove a user and a POI with a visit frequency smaller than a predetermined number of times from the third preprocessing data to generate the input data.

In one implementation, the processor may train the POI recommendation model based on a first model that learns a movement pattern of a user over time based on the input data, a second model that scores a distance between the user and a POI and personalizes the scored distance value for each user, and a third model that receives an age and a gender of the user, a POI category, and an output value output from the first model.

In one implementation, the processor may train the POI recommendation model to dot-product an output value output from the second model and an output value output from the third model and output a place the user is expected to visit.

In one implementation, the processor may generate the first model based on a TimelyRec model.

In one implementation, the TimelyRec model may include a first learning device that learns a periodic behavior pattern of the user over the time and a second learning device that learns a sequential behavior pattern of the user over the time.

In one implementation, the processor may score the distance between the user and the POI based on a radial basis function (RBF) kernel.

In one implementation, the processor may personalize the scored distance value for each user based on a distance score model.

In one implementation, the processor may generate the third model based on a multi-layer perceptron (MLP) neural network.

In one implementation, the processor may output the at least one place the requestor is expected to visit via an output device.

According to another aspect of the present disclosure, a method for controlling a vehicle includes acquiring big data including a POI with a visit history of a requestor who has requested a place recommendation, performing preprocessing on the big data for learning acquired in advance to generate input data, training a POI recommendation model based on the input data, and inputting the big data into the POI recommendation model that has been trained to generate at least one place the requestor is expected to visit.

In one implementation, the performing of the preprocessing on the big data for learning acquired in advance to generate the input data may include extracting user information and POI information from the big data for the learning and generating first preprocessing data, extracting a POI with a history of being set as a destination from the first preprocessing data and generating second preprocessing data, extracting only a POI category to be learned from the second preprocessing data and generating third preprocessing data, and removing a user and a POI with a visit frequency smaller than a predetermined number of times from the third preprocessing data to generate the input data.

In one implementation, the training of the POI recommendation model may include training the POI recommendation model based on a first model that learns a movement pattern of a user over time based on the input data, a second model that scores a distance between the user and a POI and personalizes the scored distance value for each user, and a third model that receives an age and a gender of the user, a POI category, and an output value output from the first model.

In one implementation, the training of the POI recommendation model may include training the POI recommendation model to dot-product an output value output from the second model and an output value output from the third model and outputting a place the user is expected to visit.

In one implementation, the method may further include generating the first model based on a TimelyRec model.

In one implementation, the TimelyRec model may include a first learning device that learns a periodic behavior pattern of the user over the time and a second learning device that learns a sequential behavior pattern of the user over the time.

In one implementation, the method may further include scoring the distance between the user and the POI based on a radial basis function (RBF) kernel.

In one implementation, the method may further include personalizing the scored distance value for each user based on a distance score model.

In one implementation, the method may further include generating the third model based on a multi-layer perceptron (MLP) neural network.

In one implementation, the method may further include outputting the at least one place the requestor is expected to visit via an output device.

### BRIEF DESCRIPTION OF THE FIGURES

The above and other objects, features and advantages of the present disclosure will be more apparent from the following detailed description taken in conjunction with the accompanying drawings:

FIG. 1 is a diagram showing a configuration of a vehicle control device according to an embodiment of the present disclosure;

FIG. 2 is a diagram showing a POI recommendation model learned according to an embodiment of the present disclosure;

FIGS. 3 and 4 are diagrams showing a vehicle control method according to an embodiment of the present disclosure; and

FIG. 5 illustrates a configuration of a computing system for executing a method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

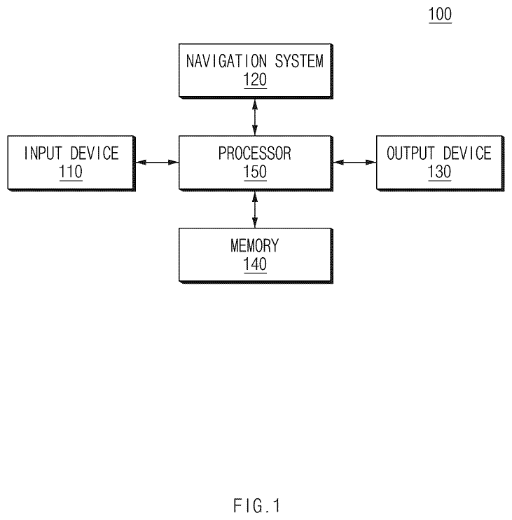

FIG. 1 is a diagram showing a configuration of a vehicle control device according to an embodiment of the present disclosure.

As shown in FIG. 1, a vehicle control device 100 may include an input device 110, a navigation system 120, an output device 130, a memory 140, and a processor 150.

The input device 110 may receive an input corresponding to a touch, a motion, or a voice of a requestor requesting a place recommendation and transmit the input to the processor 150, and the processor 150 may control an operation of the vehicle control device in response to the input information. According to one embodiment, the input device 110 may include touch input means or mechanical input means. As an example, the input device 110 may be disposed in one area of a steering wheel, and the requestor may manipulate the input device 110 with a finger while gripping the steering wheel. As another example, the input device 110 may be implemented with at least one of a motion sensor or a voice recognition sensor that senses the motion or the voice of the requestor, or any combination thereof.

The navigation system 120 may acquire big data for learning. In this regard, the big data for the learning may include data input to generate a point of interest (POI) recommendation model according to one embodiment of the present disclosure. According to one embodiment, the navigation system 120 may acquire a POI with a visit history of a user boarded a vehicle, a POI within a predetermined distance from a position of the user, a POI set as a destination, and the like as data for the learning. In this regard, the POI may include at least one place that may be set as the destination, and may include, for example, a department store, a restaurant, a school, and the like. The navigation system 120 may also acquire big data including a POI with a visit history of the requestor who has requested the place recommendation. In this regard, the user may match the requestor or may be different therefrom.

The navigation system 120 may be equipped with a GPS receiver and acquire position information of the vehicle (position information of the user), and map-match the position of the vehicle with pre-stored map data to acquire the POI located within the predetermined distance from the position of the vehicle. In addition, the navigation system 120 may provide a route from a current position to the destination set by the user (or the requestor).

The output device 130 may output an image or a sound under control of the processor 150. According to one embodiment, the output device 130 may be implemented as a display device, a sound output device, or the like. In this regard, the display device may include a HUD, a cluster, and the like. According to one embodiment, the display device may be implemented as a display device employing a liquid crystal display (LCD) panel, a light emitting diode (LED) panel, an organic light emitting diode (OLED) panel, a plasma display panel (PDP), and the like. The liquid crystal display may include a thin film transistor liquid crystal display (TFT-LCD). The display device may be integrally implemented with a touch screen panel (TSP).

The memory 140 may store at least one algorithm that performs calculation or execution of various commands for the operation of the vehicle control device according to one embodiment of the present disclosure. According to one embodiment, the memory 140 may store at least one command executed by the processor 150, and the command may cause the vehicle control device of the present disclosure to operate. The memory 140 may include at least one storage medium among a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The processor 150 may be implemented by a variety of processing devices with a built-in semiconductor chip or the like that may perform the calculation or the execution of the various commands, and may control the operation of the vehicle control device according to one embodiment of the present disclosure. The processor 150 may be electrically connected to the input device 110, the navigation system 120, the output device 130, and the memory 140 via a wired cable or various circuits to transmit an electrical signal including a control command and the like and perform calculation or data processing regarding control and/or communication. The processor 150 may include at least one of a central processing unit, an application processor, or a communication processor (CP), or any combination thereof.

The processor 150 may acquire the big data for the learning in advance. The big data for the learning may include the POI visited by the user (a driver) boarded the vehicle, the POI within the predetermined distance from the position of the user, the POI set as the destination, and the like.

According to one embodiment, the processor 150 may store the big data for the learning as data in a table format using a preprocessing code to extract learning data.

The processor 150 may generate input data by performing preprocessing on the big data for the learning acquired in advance.

According to one embodiment, the processor 150 may receive user information (characteristic information for each user) of the user boarded the vehicle from a server (or a user terminal) or the like via a communication device (not shown) and add the user information to the learning data. In this regard, the user information may include a gender, an age, and the like of the user.

According to one embodiment, the processor 150 may receive POI information (characteristic information for each POI) including the POI visited by the user (the driver), the POI within the predetermined distance from the position of the user, the POI set as the destination, and the like from the server (or the user terminal) or the like via the communication device (not shown) and add the POI information to the learning data. In this regard, the POI information may include a POI ID, a POI position, a POI category, and the like. The POI category may be set by the user or by the processor 150, and may include, for example, a living convenience category, a travel leisure category, and the like. The living convenience category may include a convenience store, a supermarket, the department store, and the like, and the travel leisure category may include an accommodation, the restaurant, a tourist attraction, and the like.

The processor 150 may perform the preprocessing to extract the user information and the POI information from the big data for the learning to which the user information and the POI information have been added and generate first preprocessing data.

The processor 150 may extract a POI (a POI ID) with a history of being set as the destination by the user from the first preprocessing data and generate second preprocessing data.

The processor 150 may extract only a POI category to be learned from the second preprocessing data and generate third preprocessing data.

The processor 150 may generate the input data input to the POI recommendation model by removing a user and a POI with a visit frequency smaller than a predetermined number of times from the third preprocessing data.

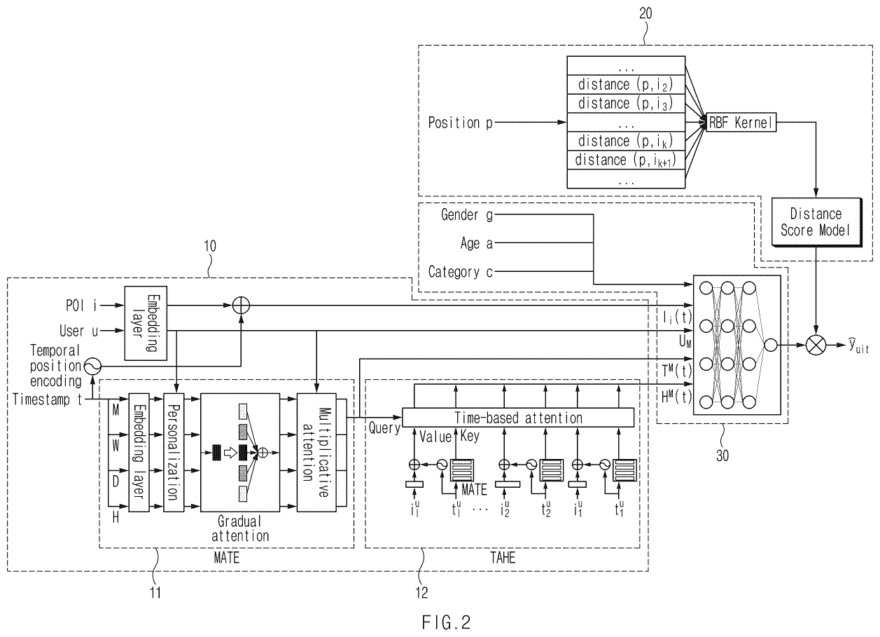

The processor 150 may train the POI recommendation model based on the input data. The operation of training the POI recommendation model will be described in detail with reference to FIG. 2.

FIG. 2 is a diagram showing a POI recommendation model learned according to an embodiment of the present disclosure.

As shown in FIG. 2, the processor 150 may train the POI recommendation model based on a first model 10 that learns a movement pattern of the user over time based on the input data.

According to one embodiment, the processor 150 may generate the first model 10 based on a TimelyRec model. The TimelyRec model may receive the user information, a current time, the POI with the visit history of the user, the POI category, and the like.

The processor 150 may include a first learning device 11 that learns a periodic behavior pattern of the user over time and a second learning device 12 that learns a sequential behavior pattern of the user over time. According to one embodiment, the first learning device 11 may include a multi-aspect time encoder (MATE), and the second learning device 12 may include a time-aware history encoder (TAHE).

However, the present disclosure may not be limited thereto, and the first model 10 may be generated based on a deep learning model by replacing the TimelyRec model, and may also be generated based on a model that may derive a final expression by receiving the user information and the POI with the visit history of the user. In this regard, the derived final expression may be combined with each POI to score each POI.

The processor 150 may train the POI recommendation model based on a second model 20 that scores a distance between the user and the POI and personalizes the scored distance value for each user.

According to one embodiment, the processor 150 may generate the second model 20 based on a radial basis function (RBF) kernel and a distance score model.

The processor 150 may score the distance between the user and the POI based on the radial basis function (RBF) kernel. The processor 150 may personalize the scored distance value for each user based on the distance score model, which learns how to use the scored distance value depending on the user.

However, the present disclosure may not be limited thereto, and the second model 20 may be generated based on a model that calculates the distance-based score by replacing the RBF kernel. For example, the model that may replace the RBF kernel may include a function that may replace a distance between the current position (a latitude and a longitude) of the user and each POI position into a score. Accordingly, in addition to recommendation of a new destination POI, recommendation of a POI around the current position may be achieved.

The processor 150 may train the POI recommendation model based on a third model 30 that receives the age of the user, the gender of the user, the POI category, and an output value output from the first model.

According to one embodiment, the processor 150 may generate the third model 30 based on a multi-layer perceptron (MLP) neural network. The processor 150 may perform embedding (a result or an entire process of converting natural language into a numeric form or a vector) on the age of the user, the gender of the user, the POI category, and the output value output from the first model, and input the embedding into the MLP neural network.

The processor 150 may train the POI recommendation model that dot-products an output value output from the second model 20 and an output value output from the third model 30 to calculate an additional point for each POI and outputs a place the user is expected to visit.

Referring again to FIG. 1, when big data of the requestor who has requested the place recommendation is acquired and the training of the POI recommendation model is completed, the processor 150 may input the big data of the requestor into the POI recommendation model that has been trained to generate at least one place the requestor is expected to visit.

According to one embodiment, the processor 150 may acquire the big data of the requestor including the POI acquired based on the visit history of the requestor who has requested the place recommendation, a time when the place recommendation was requested, and position information of the requestor, and may input the POI acquired based on the visit history of the requestor who has requested the place recommendation, the time when the place recommendation was requested, and the position information of the requestor into the POI recommendation model that has been trained.

The processor 150 may determine a recommendation algorithm and a POI category to be recommended based on an input of the requestor. In this regard, the recommendation algorithm may include, as a POI recommendation scheme, new recommendation of recommending a new POI and repeated recommendation of recommending a POI that has been recommended.

The processor 150 may input the big data of the requestor into the POI recommendation model that has been trained, and generate the at least one place the requestor is expected to visit by reflecting the recommendation algorithm and the POI category.

The processor 150 may output the at least one place the requestor is expected to visit via the output device 130.

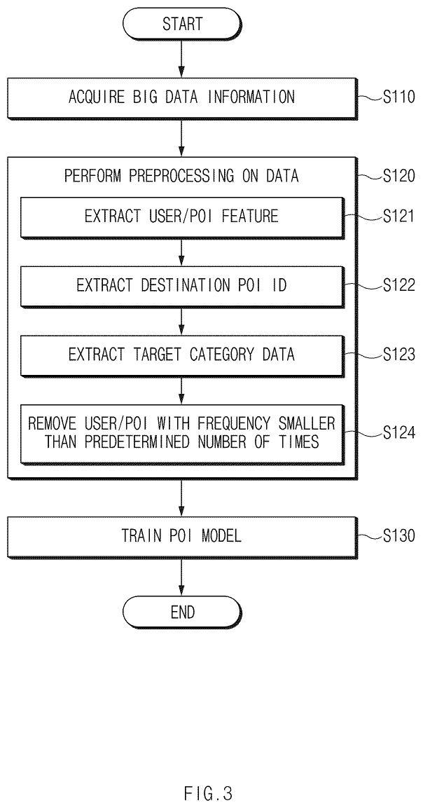

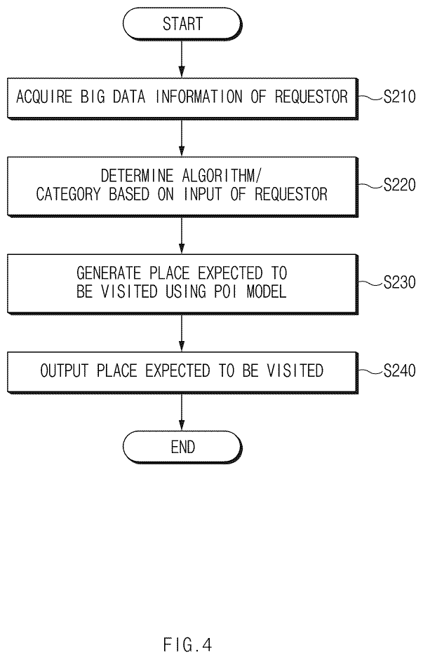

FIGS. 3 and 4 are diagrams showing a vehicle control method according to an embodiment of the present disclosure.

As shown in FIG. 3, the processor 150 may acquire the big data for the learning in advance (S110). The big data for the learning may include the POI visited by the user (the driver) boarded the vehicle, the POI within the predetermined distance from the position of the user, the POI set as the destination, and the like.

According to one embodiment, the processor 150 may store the big data for the learning as the data in the table format using the preprocessing code to extract the learning data.

The processor 150 may generate the input data by performing the preprocessing on the big data for the learning acquired in advance (S120).

The processor 150 may receive the user information (the characteristic information for each user) of the user boarded the vehicle from the server (or the user terminal) or the like via the communication device (not shown) and add the user information to the learning data. In this regard, the user information may include the gender, the age, and the like of the user.

According to one embodiment, the processor 150 may receive the POI information (the characteristic information for each POI) including the POI visited by the user (the driver), the POI within the predetermined distance from the position of the user, the POI set as the destination, and the like from the server (or the user terminal) or the like via the communication device (not shown) and add the POI information to the learning data. In this regard, the POI information may include the POI ID, the POI position, the POI category, and the like. The POI category may be set by the user or by the processor 150, and may include, for example, the living convenience category, the travel leisure category, and the like. The living convenience category may include the convenience store, the supermarket, the department store, and the like, and the travel leisure category may include the accommodation, the restaurant, the tourist attraction, and the like.

The processor 150 may perform the preprocessing to extract the user information and the POI information from the big data for the learning to which the user information and the POI information have been added and generate the first preprocessing data (S121).

The processor 150 may extract the POI (the POI ID) with the history of being set as the destination by the user from the first preprocessing data and generate the second preprocessing data (S122).

The processor 150 may extract only the POI category to be learned from the second preprocessing data and generate the third preprocessing data (S123).

The processor 150 may generate the input data input to the POI recommendation model by removing the user and the POI with the visit frequency smaller than the predetermined number of times from the third preprocessing data (S124).

The processor 150 may train the POI recommendation model based on the input data (S130).

According to one embodiment, in S130, the processor 150 may train the POI recommendation model based on the first model 10 that learns the movement pattern of the user over time based on the input data.

According to one embodiment, the processor 150 may generate the first model 10 based on the TimelyRec model. The TimelyRec model may receive the user information, the current time, the POI with the visit history of the user, the POI category, and the like.

The processor 150 may include the first learning device 11 that learns the periodic behavior pattern of the user over time and the second learning device 12 that learns the sequential behavior pattern of the user over time. According to one embodiment, the first learning device 11 may include the multi-aspect time encoder (MATE), and the second learning device 12 may include the time-aware history encoder (TAHE).

However, the present disclosure may not be limited thereto, and the first model 10 may be generated based on the deep learning model by replacing the TimelyRec model, and may also be generated based on the model that may derive the final expression by receiving the user information and the POI with the visit history of the user. In this regard, the derived final expression may be combined with each POI to score each POI.

The processor 150 may train the POI recommendation model based on the second model 20 that scores the distance between the user and the POI and personalizes the scored distance value for each user.

According to one embodiment, the processor 150 may generate the second model 20 based on the radial basis function (RBF) kernel and the distance score model.

The processor 150 may score the distance between the user and the POI based on the radial basis function (RBF) kernel. The processor 150 may personalize the scored distance value for each user based on the distance score model, which learns how to use the scored distance value depending on the user.

However, the present disclosure may not be limited thereto, and the second model 20 may be generated based on the model that calculates the distance-based score by replacing the RBF kernel. For example, the model that may replace the RBF kernel may include the function that may replace the distance between the current position (the latitude and the longitude) of the user and each POI position into the score. Accordingly, in addition to the recommendation of the new destination POI, the recommendation of the POI around the current position may be achieved.

The processor 150 may train the POI recommendation model based on the third model 30 that receives the age of the user, the gender of the user, the POI category, and the output value output from the first model.

According to one embodiment, the processor 150 may generate the third model 30 based on the multi-layer perceptron (MLP) neural network. The processor 150 may perform the embedding (the result or the entire process of converting the natural language into the numeric form or a vector) on the age of the user, the gender of the user, the POI category, and the output value output from the first model, and input the embedding into the MLP neural network.

The processor 150 may train the POI recommendation model that dot-products the output value output from the second model 20 and the output value output from the third model 30 to calculate the additional point for each POI and outputs the place the user is expected to visit.

As shown in FIG. 4, when the big data of the requestor who has requested the place recommendation is acquired and the training of the POI recommendation model is completed, the processor 150 may input the big data of the requestor into the POI recommendation model that has been trained to generate the at least one place the requestor is expected to visit.

According to one embodiment, the processor 150 may acquire the big data of the requestor including the POI acquired based on the visit history of the requestor who has requested the place recommendation, the time when the place recommendation was requested, and the position information of the requestor (S210).

The processor 150 may determine the recommendation algorithm and the POI category to be recommended based on the input of the requestor (S220). In this regard, the recommendation algorithm may include, as the POI recommendation scheme, the new recommendation of recommending the new POI and the repeated recommendation of recommending the POI that has been recommended.

The processor 150 may input the POI acquired based on the visit history of the requestor who has requested the place recommendation, the time when the place recommendation was requested, and the position information of the requestor into the POI recommendation model that has been trained, and generate the at least one place the requestor is expected to visit by reflecting the recommendation algorithm and the POI category selected by the user (S230).

The processor 150 may output the at least one place the requestor is expected to visit via the output device 130 (S240).

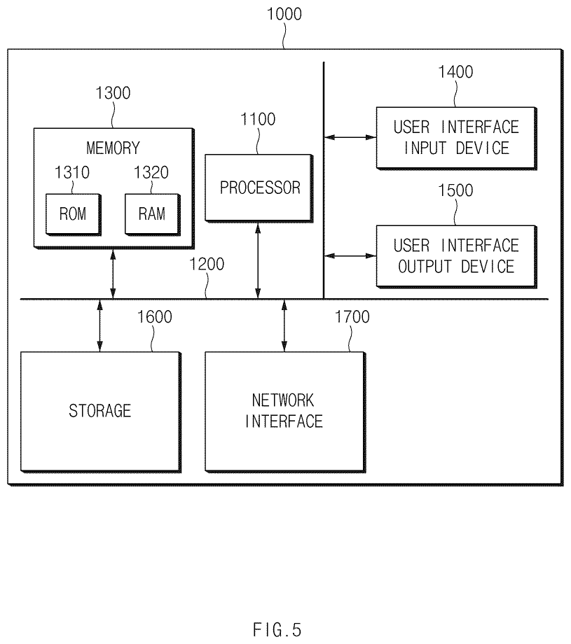

FIG. 5 illustrates a configuration of a computing system for executing a method according to an embodiment of the present disclosure.

With reference to FIG. 5, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the vehicle according to one embodiment of the present disclosure may generate the POI recommendation model for each POI category and recommend the place the user is expected to visit considering the position of the user, the current time, the age of the user, and the POI category selected by the user.

The device and the method for controlling the vehicle according to one embodiment of the present disclosure may generate the POI recommendation model that learns the movement pattern of the user over time, scores the distance between the user and the POI, personalizes the scored distance value, and outputs the place the user is expected to visit based on the movement pattern of the user over time and the scored distance value.

The device and the method for controlling the vehicle according to one embodiment of the present disclosure may provide the place recommendation service that outputs the place the user is expected to visit by considering not only the position of the user but also the movement pattern over time to enable the intuitive recognition of the user and improve the satisfaction of the user.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A device for controlling a vehicle, the device comprising:
a navigation system configured to acquire big data including a point of interest (POI) with a visit history of a requestor who has requested a place recommendation; and
a processor configured to:
perform preprocessing on the big data for learning acquired in advance to generate input data;
train a POI recommendation model based on the input data; and
input the big data into the POI recommendation model that has been trained to generate at least one place the requestor is expected to visit.

2. The device of claim 1, wherein the processor is further configured to:
perform the preprocessing to extract user information and POI information from the big data for the learning and generate first preprocessing data;
extract a POI with a history of being set as a destination from the first preprocessing data and generate second preprocessing data;
extract only a POI category to be learned from the second preprocessing data and generate third preprocessing data; and
remove a user and a POI with a visit frequency smaller than a predetermined number of times from the third preprocessing data to generate the input data.

3. The device of claim 1, wherein the processor is further configured to train the POI recommendation model based on:
a first model configured to learn a movement pattern of a user over time based on the input data;
a second model configured to score a distance between the user and a POI and personalize the scored distance for each user; and
a third model configured to receive an age and a gender of the user, a POI category, and an output value output from the first model.

4. The device of claim 3, wherein the processor is further configured to train the POI recommendation model to dot-product an output value output from the second model and an output value output from the third model and output a place the user is expected to visit.

5. The device of claim 3, wherein the processor is further configured to generate the first model based on a TimelyRec model.

6. The device of claim 5, wherein the TimelyRec model includes a first learning device configured to learn a periodic behavior pattern of the user over the time and a second learning device configured to learn a sequential behavior pattern of the user over the time.

7. The device of claim 3, wherein the processor is further configured to score the distance between the user and the POI based on a radial basis function (RBF) kernel.

8. The device of claim 3, wherein the processor is further configured to personalize the scored distance value for each user based on a distance score model.

9. The device of claim 3, wherein the processor is further configured to generate the third model based on a multi-layer perceptron (MLP) neural network.

10. The device of claim 1, wherein the processor is further configured to output the at least one place the requestor is expected to visit via an output device.

11. A method for controlling a vehicle, the method comprising:
acquiring, by a navigation system, big data including a point of interest (POI) with a visit history of a requestor who has requested a place recommendation;
performing, by a processor, preprocessing on the big data for learning acquired in advance to generate input data;
training, by the processor, a POI recommendation model based on the input data; and
inputting, by the processor, the big data into the POI recommendation model that has been trained to generate at least one place the requestor is expected to visit.

12. The method of claim 11, wherein performing the preprocessing on the big data for learning acquired in advance to generate the input data includes:
extracting user information and POI information from the big data for the learning and generating first preprocessing data;
extracting a POI with a history of being set as a destination from the first preprocessing data and generating second preprocessing data;
extracting only a POI category to be learned from the second preprocessing data and generating third preprocessing data; and
removing a user and a POI with a visit frequency smaller than a predetermined number of times from the third preprocessing data to generate the input data.

13. The method of claim 11, wherein training the POI recommendation model includes:
training the POI recommendation model based on a first model configured to learn a movement pattern of a user over time based on the input data, a second model configured to score a distance between the user and a POI and personalize the scored distance for each user, and a third model configured to receive an age and a gender of the user, a POI category, and an output value output from the first model.

14. The method of claim 13, wherein training the POI recommendation model further includes:
training the POI recommendation model to dot-product an output value output from the second model and an output value output from the third model and outputting a place the user is expected to visit.

15. The method of claim 13, further comprising:
generating the first model based on a TimelyRec model.

16. The method of claim 15, wherein the TimelyRec model includes a first learning device configured to learn a periodic behavior pattern of the user over the time and a second learning device configured to learn a sequential behavior pattern of the user over the time.

17. The method of claim 13, further comprising:
scoring the distance between the user and the POI based on a radial basis function (RBF) kernel.

18. The method of claim 13, further comprising:
personalizing the scored distance value for each user based on a distance score model.

19. The method of claim 13, further comprising:
generating the third model based on a multi-layer perceptron (MLP) neural network.

20. The method of claim 11, further comprising:
outputting the at least one place the requestor is expected to visit via an output device.
